(19) United States
(12) Patent Application Publication
(10) Pub. No.: US 2008/0174659 A1
(43) Pub. Date: Jul. 24, 2008

(54) Wide field of view display device and method

(76) Inventor: Ian McDowall, Woodside, CA (US)

Correspondence Address: CROCKETT + CROCKETT, Suite 400, 24012 CALLE DE LA PLATA, Laguna Mills, CA, 92653, US

(21) Appl. No.: 11/654,984

(22) Filed: Jan. 18, 2007

(51) Int. Cl. H04N 15/00

(52) U.S. Cl. 348/53; 348/E15.001

(57) ABSTRACT

Head mounted displays with wide fields of view are desired. A method and device for creating suitable images for use in stereoscopic wide field of view displays is disclosed. The device and method enable the creation of pre-distorted images which appear correct to the viewer. The source imagery for the device and method are created using standard techniques.

### BACKGROUND

Head-mounted displays (HMDs) find application in many different areas, including training, entertainment, and educational fields. In order for an HMD user to suspend disbelief and really buy into the virtual world experience, it is important that the HMD provide a very wide field of view (FOV) image. That is, the image displayed by the HMD should ideally have a horizontal dimension sufficiently wide to fill most if not all of a user's horizontal field of vision, thereby engaging his or her peripheral vision. Otherwise, the image a user sees in an HMD occupies only the center of his or her vision and thus appears as if the user is viewing the image at the end of a tunnel. Such viewing experiences are not as convincingly real as wide FOV immersive environments.

The optics that are practical to use in terms of cost, size, and physical implementation in wide FOV HMDs tend to have fish-eye distortion characteristics. Thus, conventional images viewed through wide FOV optics tend to have a distorted look. Images are also magnified more in the center of the image than at the edges, and perceived pixel density differs between the center of the image and the periphery, despite the fact that most displays, screens, or projectors used with HMDs have a uniform pixel density across their display area. These last two performance characteristics of wide FOV optics are actually advantageous to have in an HMD due to certain physiological considerations of human eyesight. Humans see greater detail in the center of their vision and rely on peripheral vision for visual flow, motion detection, and context clue type information. The lens characteristics of wide FOV optics facilitate this by using more display pixels in the vicinity of the center of a user's vision while spreading fewer pixels out at the edge of vision where detail is not needed as much.

Unfortunately, due to the method by which images are rendered by a computer, it is difficult to fully realize these advantageous optical characteristics of wide FOV optics. While a computer can correct for the optical “fish-eye” distortion caused by the wide FOV optics using an image mapping transform, the geometric differences between how an image is rendered on a screen and how an HMD user perceives an image through the wide FOV optics prevent the most effective use of image display pixels.

FIGS. 2 and 3, with reference to FIG. 1, illustrate the geometric differences between image rendering and image perception in greater detail. Selected components of generic wide field of view HMD 12 are illustrated in perspective view in FIG. 1. Note that only a single side (eyeball) is drawn for clarity. Display 14, which has a width A and a height B, displays an image that is focused by optics 16 onto eyeball 18. Display 14 may be a liquid crystal display (LCD) screen, an image from an LCOS micro display, a miniature projection screen, or the like. It displays images rendered by a computer (not illustrated). Display 14 has a uniform pixel density across area A×B. Optics 16, while drawn as a single element, may include multiple elements, diffusers, polarizers, and the like. Optics 16 are designed to focus wide field of view images and have fish-eye (or close to fish-eye) lens optical characteristics. FIG. 2 illustrates in overhead view the geometric relationship that results from image rendering, in the case where the eye looks at a display, no HMD optics are involved. The computer (not illustrated) rendering image 22 on display 14 utilizes virtual eye point 20 in order to determine the perspective of image 22. The virtual eye point is located distance h from the display, and is centered horizontally with respect to the display. Note that distance h is perpendicular to display 14. Pixel 24, at the edge of image 22, is located horizontal distance x from the virtual eye point. Pixel 24 subtends angle θ with virtual eye point 20. Based on the right triangle formed by distance x and distance h, the tangential relationship between pixel distance x, virtual eye point distance h, and angle θ is:

h*tan(θ)=x

The geometric relationship describing how image pixels are perceived through wide FOV optics is not tangential, however, as it is with rendering. FIG. 3 illustrates in overhead view the approximate end-result geometric relationship regarding pixel perception with wide FOV optics. Again, a computer (not illustrated) renders image 22 on display 14. Optics 16 focus the image on eyeball 18, which is located distance z from the display. Note that distance z is perpendicular to display 14. Pixel 24, at the edge of image 22, is located horizontal distance x from the eyeball. Because optics 16 warp image 22, the angle pixel 24 appears to subtend with eyeball 18 is angle α. Due to optics 16, the geometric relationship describing the angular perception of pixels versus distance x is approximately:

k*α=x

where “k” is a constant determined by the elements of optics 16, the area of display 14, and the like. The geometric relationship describing image pixel angles and distances is tangential on the rendering side and roughly linear on the user perception side; a user will therefore perceive images differently than the computer intended.

The consequence of this geometric mismatch between image rendering and image perception is that straight lines in a picture may appear curved and unnatural when viewed in a wide FOV HMD. In order for an HMD user to feel immersed in a particular virtual environment, the image he or she is viewing must be wide field of view. Wide FOV images occupy a large area (14 in FIG. 2), and thus require many pixels to render, which standard computer rendering schemes like Open GL spread out evenly over a picture as described above. Small details or features in the center of a wide FOV image are thus rendered using only a few pixels, if any at all. In a wide FOV HMD, however, small features in the center of an image actually cover many pixels because of the perceived relatively high density of pixels there, as well as the lower magnification there. But, because the picture is rendered by the computer has few pixels in that area, the features in the viewed image look blocky and unnatural, even if the image is resampled to correct for the distortion. This rendering/viewing phenomenon is illustrated in more detail in FIG. 4 and FIG. 5. FIG. 4 depicts a wide FOV virtual world image typical of those used in HMDs. It is rendered using Open GL. Person 30 standing in the center of FIG.4 is a small feature of the image and thus covers very few pixels. If the image is viewed without the aid of wide FOV optics, person 30 does not appear unusually blocky or unlifelike. When area 32 of the image is enlarged by wide FOV optics, though, as seen in inset 34, FIG. 30 appears blocky, pixilated, and generally un-lifelike. This is despite the fact that, when viewed using a wide FOV HMD, more pixels are available in that area that could be used to smooth out the pixilation of person 30 and make it more detailed and lifelike. FIG. 5 depicts the same virtual world as in FIG. 4, only this time a narrow FOV image is illustrated. The image is also rendered using Open GL. Since the details in FIG. 5 are larger, due to the narrower field of view image compared to FIG. 4, more pixels are available to cover each detail. Thus, person 38, as shown in inset 36, looks less blocky and more convincingly real than person 30 in FIG. 4.

It is undesirable to use a non-standard image rendering scheme that better matches the geometric characteristics of the wide FOV optics, because such rendering schemes are difficult to devise in the first place and may introduce lag into the system performance. System lag manifests itself on the user's end as jerky, poorly tracked image movement that can quickly lead to user nausea. On the other hand, it is obviously desirable to fully utilize the higher perceived central pixel density and magnification properties of the wide field of view optics employed in many virtual reality head mounted displays. Accordingly, a need exists for an image stitching device and method.

### DESCRIPTION OF FIGURES

FIG. 1 schematically illustrates in perspective view selected components of a generic wide field of view head mounted display;

FIG. 2 schematically illustrates in overhead view the geometric relationship describing how images are typically rendered by a computer;

FIG. 3 schematically illustrates in overhead view the approximate end-result geometric relationship describing pixel perception as viewed through wide field of view optics;

FIG. 4 illustrates a wide field of view image of a typical virtual reality environment;

FIG. 5 illustrates a narrow field of view image of a typical virtual reality environment;

FIG. 6 schematically illustrates an application of an image stitching device in accordance with an embodiment of the invention;

FIG. 7 illustrates a representative image of the kind utilized by an embodiment of the invention; and

FIG. 8 illustrates representative images of the kind output by an embodiment of the invention.

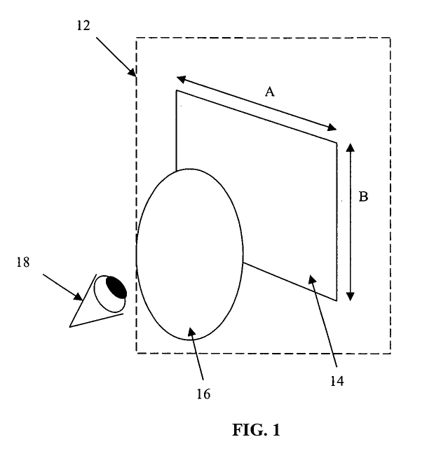

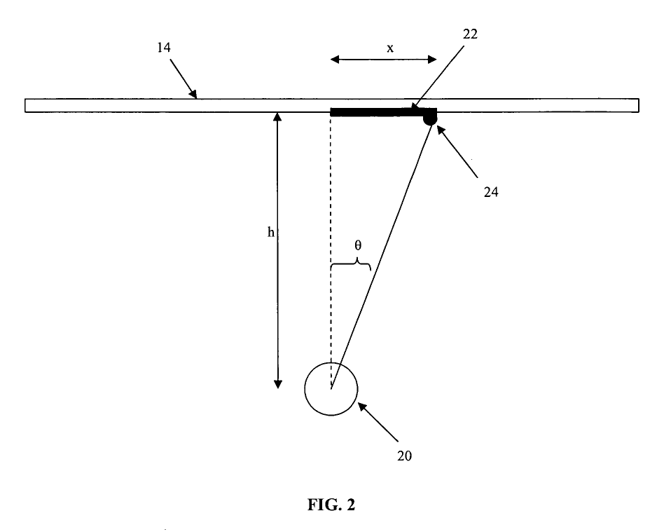

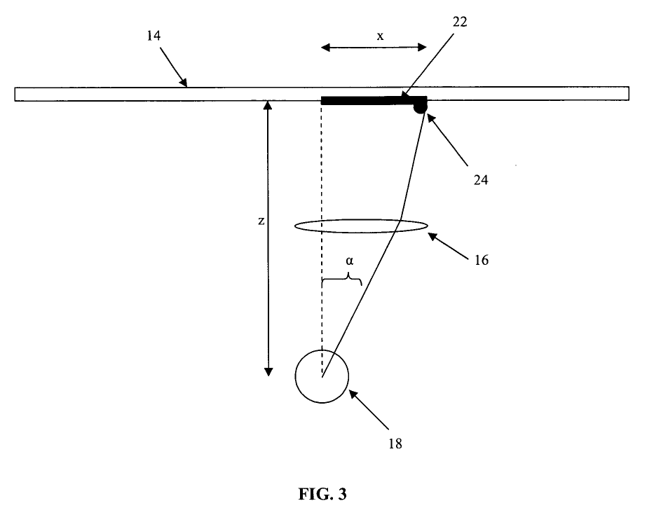

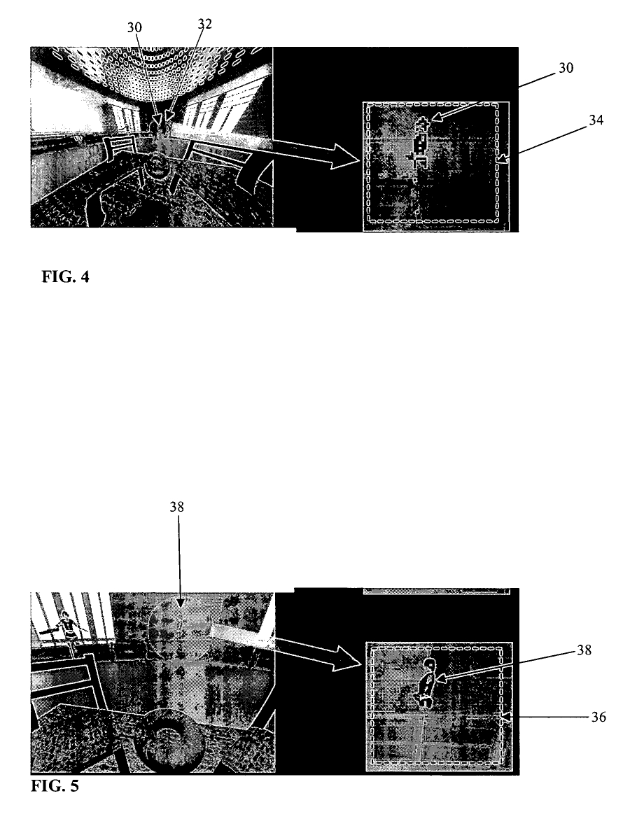

### INNOVATION

An image stitching device and method creates a composite image displayed in a wide field of view head mounted display that meshes high central-image detail with engaging wide-angle elements. Thus a head mounted display user gets both smooth, lifelike central image features and full use of peripheral vision. The image stitching device works in conjunction with a computer that renders both narrow-angle view image(s) of the center of a given virtual world and wide-angle view image(s) of the same virtual world. The image stitching device then resamples the wide and narrow angle view images, stitching the narrow angle view image(s) into the center of the wide angle view image(s). The final image has higher detail in the center of the user-perceived image, where perceived pixel density is highest and can therefore support the most detail, while still providing an engaging, wide field of view image. The rendering scheme employed by the computer may be a standard scheme such as Open GL, so there is very little additional lag time added to the system, minimizing user discomfort. The image stitching device may utilize as few as two images (a narrow-angle view image and a wide-angle view image) or scale up and use as many images as is practical or possible with the given hardware. The resampling of the image is also such that it corrects for other visual artifacts. In the images that are rendered by the PC, straight lines are drawn as such. Images for optics which geometrically distort the images require that during the resampling process, the displayed pixels are sampled from the incoming images in such a way as to invert the distortion introduced by the optical system. This can be accomplished both in a geometric sense and may also be done to correct for lateral color distortion in the images seen through the optics.

Physical Description

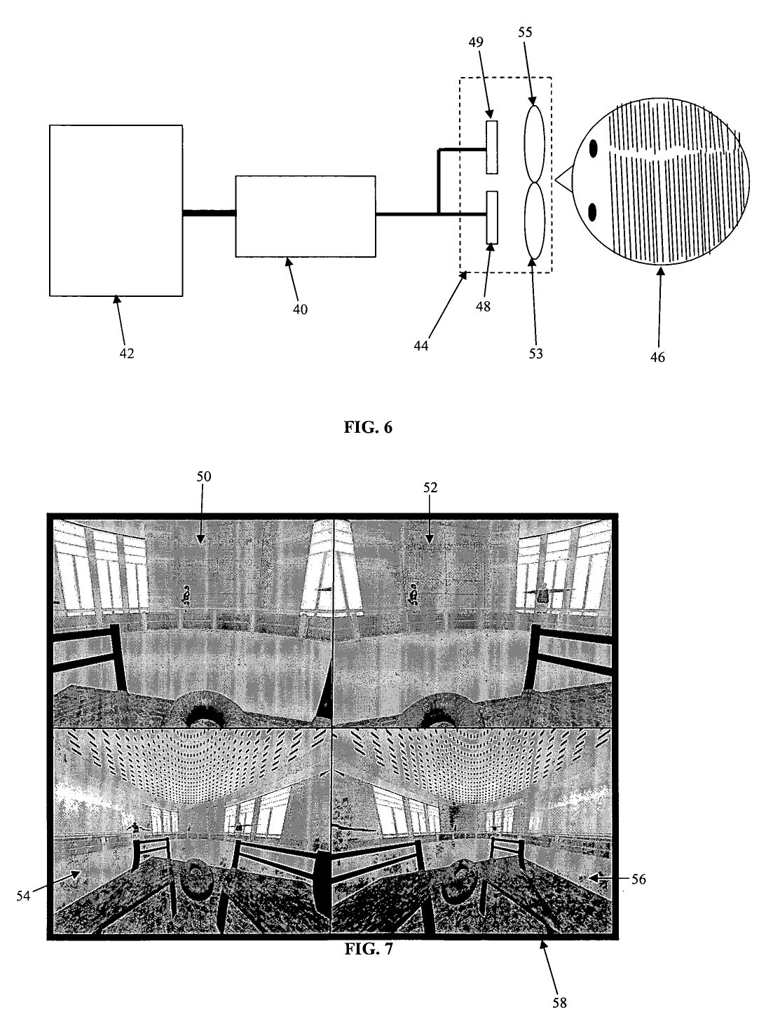

FIG. 6 schematically illustrates an application of an image stitching device in accordance with an embodiment of the invention. Image stitching device 40 is a hardware component comprised of electronics such as circuit boards, memory, and the like and is designed to resample images rendered by computer 42 according to a pre-programmed mapping transform. This mapping transform is stored in memory (not illustrated) in image stitching device 40. The creation of the mapping function or look up table may come from simulations of the optics or other sources. Computer 42 is a standard desktop or laptop computer running a typical operating system such as Windows, MAC OS, or the like. Computer 42 renders images using a standard rendering function such as OpenGL, DirectX, or the like. Computer 42 outputs rendered images to image stitching device 40 using a standard computer data interface such as DVI, or the like. In the preferred embodiment of the invention, image stitching device 40 receives rendered images from computer 42 over a single digital visual interface (DVI) channel. Image stitching device 40 outputs the resampled images to wide FOV head mounted display (HMD) 44 using a standard computer data interface such as DVI, or the like. In the preferred embodiment of the invention, image stitching device 40 outputs resampled to wide FOV HMD 44 over a single digital visual interface (DVI) channel. Wide FOV HMD 44 is drawn in top-view cross-section, and is viewed by HMD user 46. Wide FOV HMD 44 is comprised of left display 48, right display 49, left viewing optics 53 and right viewing optics 55. The left and right displays may be LCD panels, LCOS micro displays, projection screens, or the like. Although the left and right displays are illustrated as direct-view panels, those of skill in the art will recognize projection units are equally applicable. As illustrated, the left and right displays and optics are both single panel units, although they could in fact be multi-panel or faceted units without departing from the spirit of the invention. The left and right viewing optics are wide FOV optics with fish-eye like lens optical properties. That means the left and right viewing optics obey a roughly linear (often with a 3 or 5^{th} order correction) mapping function characteristic of fish-eye lenses. This causes images on the displays to appear to have a higher density of pixels in the center of the image than at the periphery of the image where pixels appear to cover a larger angle. The viewing optics also have lower magnification in the center of the optics than out at the edges of the optics. Those of skill in the art will recognize that while the left and right viewing optics are drawn as single lenses, they could in fact contain multiple lens groups, filters, diffusers, and the like without departing from the spirit of the invention. Images output from image stitching device 40 are displayed on the left and right displays; the left and right viewing optics then focus these images so HMD user 46 can clearly see them. The images output from image stitching device 40 may be stereoscopic if wide FOV HMD 44 is a binocular stereo HMD or they may only be tiled (left-right) images. For illustrative purposes, it is assumed wide FOV HMD 44 is a binocular stereo HMD and the images output from image stitching device 40 are stereoscopic.

Method

The following explanation of operation is strictly for illustrative purposes and is not intended to limit the scope of the invention. Those of skill in the art will recognize that additional embodiments of the invention are possible without departing from the spirit of the invention. The following explanation deals with an image stitching device that utilizes four separate images (a narrow field of view image and a wide field of view image, one pair for each eye) in order to generate two high detail, wide field of view images, one for the left eye and one for the right eye. The images in this description are stereoscopic, so when a user views the images in a wide field of view HMD, the images meld together to form a detailed, stereoscopic, wide field of view image that is engaging and lifelike. In this illustrative example both left display 48 and right display 49 are small LCD displays of M×N pixels.

With reference to FIG. 7 and continuing reference to FIG. 6, in operation, computer 42 renders four different images based on the current scene HMD user 46 is viewing in a given virtual world. Each of these four images is composed of 800 (horizontal)×600 (vertical) pixels. The images are tiled together and output to image stitching device 40 as a single 1600 (horizontal)×1200 (vertical) pixel image. A representative 1600×1200 pixel image is illustrated in FIG. 7. Image 58 is comprised of image 50, image 52, image 54, and image 56. Image 50 and image 54 are both left eye viewpoint images, while image 52 and image 56 are both right eye viewpoint images. Image 50 and image 52 are narrow field of view images, each covering a field of view approximately 800 vertical and 96.40 horizontal. Image 54 and image 56 are wide field of view images, each covering a field of view approximately 1400 vertical and 155.40 horizontal. Images 50, 52, 54, and 56 are rendered using Open GL, although those of skill in the art will realize that any standard computer image rendering scheme may be utilized without departing from the spirit of the invention. Computer 42 renders the 800×600 images based on virtual eye points, with one virtual eye point for the left and one virtual eye point for the right eye image. The images rendered by computer 42 are what each virtual eye point “sees” in the virtual world given the HMD user's present location in the virtual world and the constraint of the given field of view for that image. The relative location of the virtual eye points in the virtual world is configured in software on computer 42 based on considerations such as the distance between the HMD user's eyes, height, type of HMD tracker (not illustrated) used and the like. Software implementation of virtual eye points is familiar to those of skill in the art and is omitted for brevity here. In the preferred embodiment of the invention the two virtual eye points for a single side (eye) at a given time are located in the same position at the center of projection, although the orientation of the virtual eye (or view vector) may vary. For example, the virtual eye point that determines image 50 and the virtual eye point that determines image 54 both have the same center of projection at a given time, although the virtual eye point that determines image 50 looks “downward” in the virtual world by an additional 5° with respect to the virtual eye point that determines image 54. Otherwise, if the centers of projection for a single eye were different, image features would not line up correctly in the final stitched images, creating a discontinuity in the images seen by HMD user 46.

Those of skill the art will realize that both the field of view angles and resolutions of images 50, 52, 54, and 56 are system configurations utilized in one particular embodiment of the invention. Different field of view angles as well as image resolutions may be used without departing from the spirit of the invention. The images also need not be the same resolution as one another.

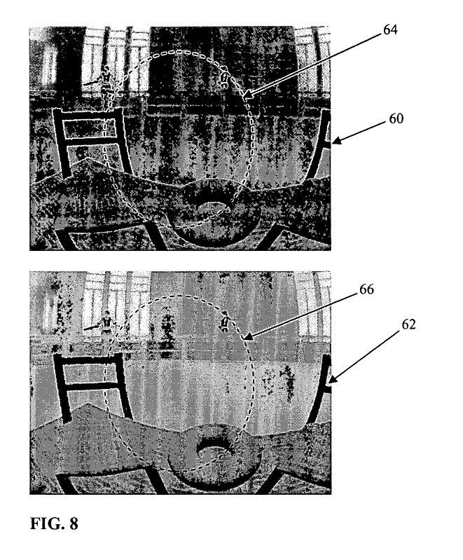

After computer 42 outputs image 58 to image stitching device 40, the image stitching device resamples image 58 and outputs two composite images (one for the left eye and one for the right eye) to wide FOV HMD 44, which consequently displays the left eye image on left display 48 and the right eye image on right display 49. With reference to FIG. 8 and continued reference to FIGS. 6 and 7, image stitching device 40 resamples image 58 by mapping pixels from image 58 to pixels in composite image 60 and composite image 62 (illustrated in FIG. 8). Both composite image 60 and composite image 62 are M (horizontal)×N (vertical) pixel images. Pixels from image 50 and image 54 are mapped to composite image 60, while pixels from image 52 and image 56 are mapped to composite image 62. The resampling may be based on point sampling or interpolation depending on the desired image quality and hardware complexity. Using point sampling to create composite image 60 and composite image 62 involved looking up comprise image 58, only selected pixels that are mapped from image 58 to composite images 60 and 62. At the boundary between images 60 and 64 (or 62 and 66) there are two possible locations in image 58 to source an output pixel from. To minimize visual artifacts, the boundary can be dithered or blended so the seam is not distracting even if the images contain slight differences. The pixel mapping is performed by image stitching device 40 according to a mapping transform stored in memory. Image warping and mapping methods are familiar to those of skill in the art and will not be explained here. In this manner the two left eye viewpoint images from image 58 are “stitched” together to form a composite left eye viewpoint image, and the two right eye viewpoint images from image 58 are “stitched” together to form a composite right eye viewpoint image. As FIG. 8 demonstrates, the composite images contain both the wide field of view context information from images 54 and 56 as well as high detail in areas 64 and 66 in the center of the composite images that are obtained from images 50 and 52. Therefore, when the composite images are viewed using wide FOV HMD 44, the detailed, immersive quality of the composite images creates a compelling and convincingly real virtual reality experience for HMD user 46. After the pixels are mapped from image 58 to composite images 60 and 62, image stitching device 40 outputs the composite images to wide FOV HMD 44, where the composite images are viewed by HMD user 46.

Those of skill in the art will recognize that the resolution of image 58 is based on the system requirements of a particular embodiment of the invention. Image 58 may be a different resolution, such as 1280 (horizontal)×1024 (vertical) pixels, without departing from the spirit of the invention. Likewise, the resolution of the composite images output by image stitching device 40 depends on the resolution of left display 48 and right display 49. Image stitching device 40 may output composite images of a different resolution in order to meet the system requirements of the wide FOV HMD employed without departing from the spirit of the invention.

In the preferred embodiment of the invention, the pixel mapping and resampling performed by image stitching device 40 not only stitches the narrow field of view images with the wide field of view images, the remapping of the resulting composite images counters the warping effects caused by the fish-eye optical characteristics of the left and right viewing optics in wide FOV HMD 44. The end result of viewing the pre-warped composite image with the viewing optics is an image that appears normal and natural looking. The warping transform is not performed as an additional step in the image stitching process but simply involves adjusting the mapping transform that dictates the pixel mapping between image 58 and composite images 60 and 62.

In an additional embodiment of the invention, image 58 is pre-warped by computer 42 when the image is outputted in order to counter the warping effects of viewing optics 53 and viewing optics 55. In this particular embodiment of the invention the pixel mapping performed by image stitching device 40 exists solely for stitching narrow field of view images into wide field of view images to form the composite images.

The overall system response time between HMD user 46 signaling a move in the virtual world (by changing the position of a movement tracker, joystick, or the like) and the HMD user seeing a new view in wide FOV HMD 44 is very low, due to the image stitching (and, preferably, image warping) being performed in the hardware of image stitching device 40. If the image stitching and image warping were part of a software image rendering program on computer 42, the response time would be much greater, resulting in a noticeable lag between a move in the virtual world and a new view in the wide FOV HMD. Depending on the mapping transform and how the stitching process is buffered in image stitching device 40, the lag between the image output from computer 42 to the composite images output can be a single frame or if some image tearing is acceptable, less than a millisecond. In this system, one can also minimize stereo artifacts by locating the left and right eye views such that each scan line in the source image 58 supplies pixels to the left and right images 60 and 62.

Those of skill in the art will appreciate that additional embodiments or configurations are available without departing from the spirit of the invention. For example, two narrow field of view images may be utilized per eye in order to create multiple areas of high detail. Also, image stitching device 40 may output composite images that contain pixels that are black or fade out the periphery of the image to black.

We claim:

1) An electronic device accepting a source image containing pixels wherein regions of said source image represent different views on a virtual world and producing result images by resampling portions of said source image where said result images viewed through optics present an undistorted view into said virtual world.
